(19) United States
(12) Patent Application Publication
(10) Pub. No.: US 2008/0263449 A1
(43) Pub. Date: Oct. 23, 2008

(54) Automated maintenance of pooled media content

(75) Inventors: Jordan Schwartz, Seattle, WA (US); David Parlin, Redmond, WA (US); Ryan Kabir, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/788,819

(22) Filed: Apr. 20, 2007

(51) Int. Cl. G06F 3/00

(52) U.S. Cl. 715/723

(57) ABSTRACT

Automated maintenance of media content such as digital photographs and video in a pool is provided by an arrangement where the time interval that each piece of media content remains in the pool is tracked and modified by user-behavioral factors. This “virtual age” of the media content is depicted on a representative image displayed by a graphical user interface through the use of visual metaphors that simulate the physical characteristics of an object such as a printed photograph as it ages. As the virtual age of the content increases, visual metaphors including fading or yellowing, and physical deterioration such as tattering, creasing, and ripping are overlaid as effects onto the displayed image. Older content is displayed using other respective images which have increased fading or yellowing and greater physical deterioration until, in one example, an image appears to crumble to dust, at which point the associated media content is automatically deleted from the pool.

### BACKGROUND

Media content, such as digital photographs and video, is frequently pooled from multiple different users using resources provided over distributed networks like the Internet. For example, several web-enabled services are available that provide users with an ability to upload photographs or video clips to servers that organize and display such media content in a single large media content pool. Users can view media items held in the pool which, for example, might be associated with particular subject matter or reflect contributions from users that belong to a common group or organization. The pool typically grows in size over time as new media content is added.

When the new pieces of media content are added, and the pool size increases, it may become difficult for users to distinguish new or particularly interesting items from the older ones in the pool that have already been viewed. The older media content tends to dilute the impact of other content, particularly in pools that have existed for awhile and contain a lot of content. A particular piece of media content that might be very representative of the group, or which may have a high level of emotional meaning can often get lost in a large mass of less relevant or unimportant content.

Some services address this issue by imposing date ordering by which the new media items are given priority over the older content. Thus, for example, photographs are displayed in the pool by their contribution date so that new photographs are shown first and a user may need to page or scroll the display in order to view older photographs in the pool. However, such approach is not always feasible as some services are not suited for displaying media content using any kind of prioritization or order. It may be desirable, for example, to show all the media content in a particular pool without imposing a display order, while still enabling users to readily discriminate among media content based on the length of time they have been in the pool, and manage the pool content with a minimal amount of effort.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Automated maintenance of media content such as digital photographs and video held in a pool is provided by an arrangement in which the interval of time that each piece of media content remains in the pool is tracked and modified by user-behavioral factors. This time interval, or “virtual age,” of the media content is depicted on a representative image displayed by a graphical user interface (“GUI”) through the use of visual metaphors that simulate the physical characteristics of an actual object such as a printed photograph as it ages over time. As the virtual age of the media content in the pool increases, visual metaphors including image fading or yellowing, and physical deterioration such as tattering, creasing, and ripping are overlaid as effects onto the displayed image to simulate physical aging. The visual metaphors are typically added as effects to the image only, and without modification to the underlying media content itself. Users can thus quickly and readily distinguish among newer and older media content in the pool as the representative images with simulated aging effects using the visual metaphors are viewed. Older media content in the pool is displayed by the GUI using images which have increased fading or yellowing and greater amounts of physical deterioration until, in one illustrative example, an image appears to crumble to dust, at which point the associated media content is deleted from the pool in an automated manner.

In another illustrative example, images representing respective pieces of media content in a pool exposed by a service provided at a central server are displayed by the GUI as a filmstrip displayed on a client's desktop that streams continuously with no predefined beginning or end. The filmstrip is displayed as part of a shared space that all users in a group can see and with which they can interact. As media content remains in the pool, their associated images in the filmstrip undergo simulated aging through application of visual metaphors, and also through the use of optional tags or labels that display a text-based description of the content's condition (e.g., “pristine,” “good, “fair,” “poor,” etc.) and a numerical rating (e.g., 100/100, 90/100, etc.).

Users in a group may add media content to the pool by dragging an image onto the filmstrip from their desktops and manually delete content by dragging images off the filmstrip. Comments and annotations to the images in the filmstrip may be added by users. Media content may be selected for printing or grouping into slideshows by interacting with the filmstrip images displayed by the GUI.

In addition, the virtual age of media content in the shared pool may be modified by users through use of a physical “polishing” metaphor in which a user can select an image in the filmstrip for a virtual renewal treatment that removes virtual age and rejuvenates the selected media content to a newer condition, or back to its original as-new condition. A user may either explicitly invoke the polishing feature through a command or menu item provided by the GUI, or polishing may be invoked implicitly when a user performs an activity with the media content such as adding a comment to an image in the filmstrip, creating a slideshow, or printing a piece of media content. Accordingly, older, unliked, or non-interesting media content in the shared pool will “age out” over time and be automatically deleted unless a user interacts with the media content. Only new, well-liked, or interesting pieces of media content will remain in the pool and displayed in the filmstrip to thereby ensure that their impact will not be diluted.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative shared media content environment in which a plurality of users interact with a shared media content pool on a central server;

FIG. 2 shows an illustrative arrangement in which a media content pool resides on a user's computer;

FIG. 3 shows a screen shot of an illustrative graphical user interface (“GUI”) with which users may interact with shared media content in a pool;

FIG. 4 shows a feature provided by the GUI in which media content is added or deleted from the pool; and

FIG. 5 shows a series of illustrative images in which virtual age is represented using a variety of visual metaphors for physical age of an actual object such as a printed photograph.

Like reference numerals indicate like elements in the drawings.

### DETAILED DESCRIPTION

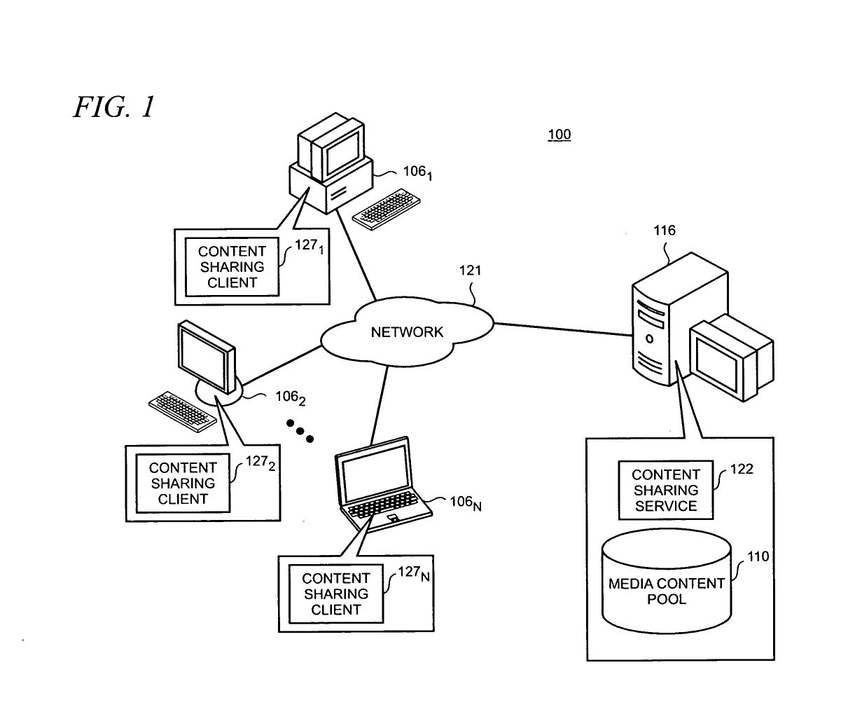

FIG. 1 shows an illustrative shared media content environment 100 in which a plurality of users at client computers 106-1, 2 . . . N interact with media content pool 110 on a server 116. Client computers 106 in the environment 100 communicate with the central server 116 over a network 121 such as the Internet. In this illustrative example, the users are part of a group that share and view media content online. Group sharing could be used, for example, by co-workers, neighbors, clubs or people having common interests or backgrounds. Sometimes groups are private where membership is restricted, while in other cases the groups are public and open to anyone. Both free and subscription-based media content sharing services are commonly available.

Group members upload media content to the central server 116, typically in the form of photographs or video in digital form. While users often upload such media content from the desktops of personal computers as shown in FIG. 1, it is emphasized that users may use other devices such as camera phones and image-capture equipment having networking capability to provide the shared media content.

Server 116 hosts a content sharing service 122 that interoperates with respective content sharing clients 127-1, 2 . . . N on client computers 106. Content sharing service 122 receives media content uploaded by the client computers 106 and exchanges messages and other data with the clients 127 as required to implement a media content sharing session.

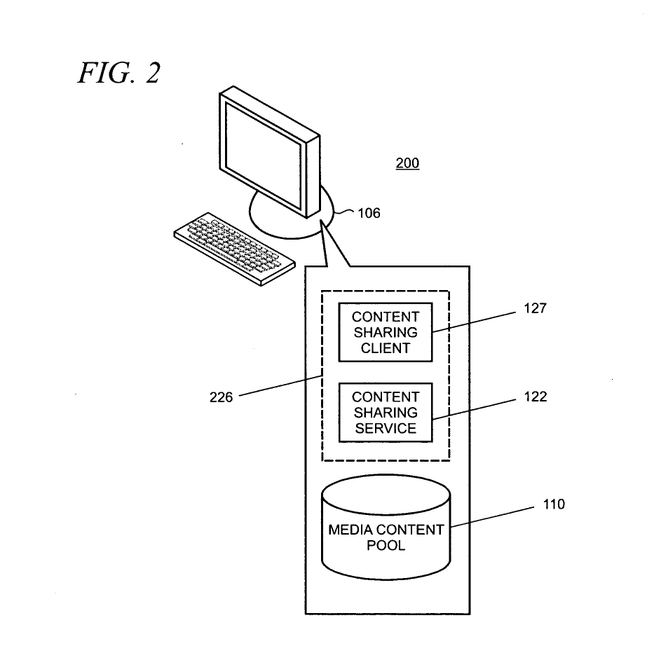

FIG. 2 shows an illustrative arrangement 200 in which the media content pool 110 resides on a user's computer 106. Arrangement 200 is typically utilized as an alternative to the client-server environment 100 shown in FIG. 1 and enables maintenance, for example, of a user's own media content using the principles described herein. Or, arrangement 200 may be used to support peer-to-peer media content sharing among a group of users (not shown) without using a central server.

As shown in FIG. 2, computer 106 includes both a media content sharing service 122 and a media content sharing client 127. In some implementations of the present automated maintenance of pooled media content, it may be desirable to incorporate the media content sharing service 122 and the media content sharing client 127 into a single software application as indicated by reference numeral 226. In other implementations, the media content sharing service 122 and media content sharing client 127 are arranged as separate processes that may communicate, for example, using an IPC (interprocess communications) process using shared memory instead of a network connection.

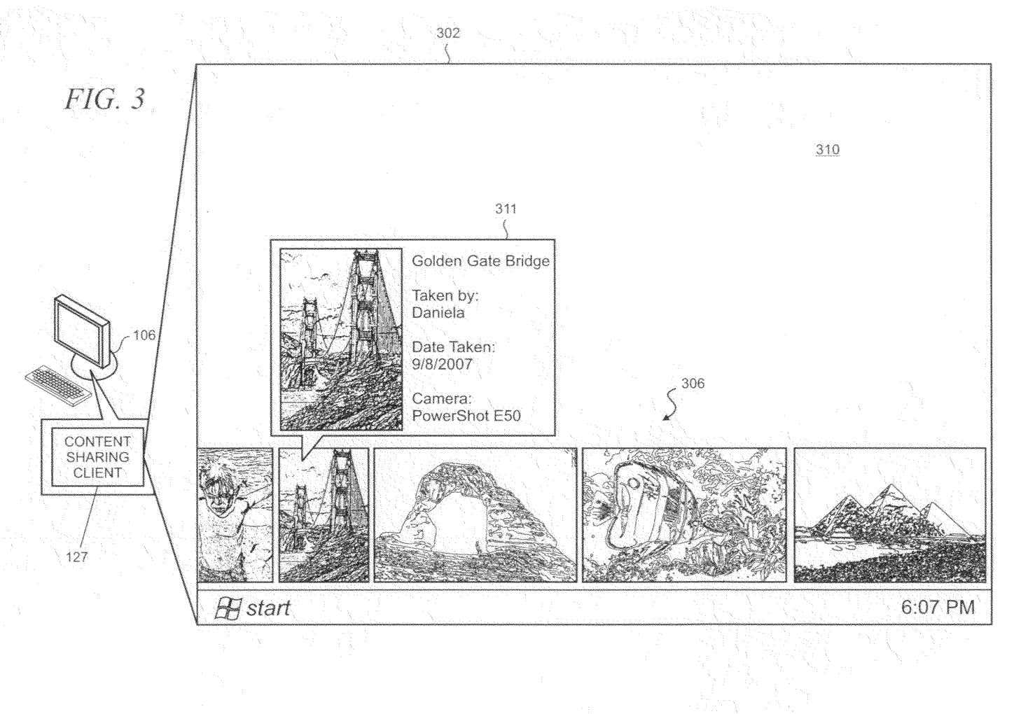

FIG. 3 shows a screen shot of an illustrative graphical user interface (“GUI”) 302 with which users may interact with media content in a shared pool. GUI 302, in this illustrative example, is arranged to display media content from a pool as a filmstrip 306 that contains a plurality of reduced-size images (e.g., thumbnails) that scroll, typically in a continuous manner, along the bottom portion of the desktop 310. However, it is emphasized that filmstrip 306 is illustrative and other display arrangements may also be used. For example, a collage, or geometric array of images and/or thumbnails, or various combinations of filmstrip, collage and array can be used depending on the requirements of a specific application of the present automated maintenance of pooled media content.

GUI 302 is displayed by each of one or more clients 127 as a shared space so that each user in a group sees the same scrolling filmstrip 306. The speed of the scrolling, size of the filmstrip 306 and other display preferences may be arranged to be user-selectable in some implementations.

Filmstrip 306 scrolls along as a continuous loop of images, with no defined beginning or end. Users can open other windows and applications on the desktop and perform various tasks and work as the filmstrip 306 scrolls (either in the background, or in a window that a user may optionally select as always on top). The media content represented by the filmstrip 306 may include both digital photographs and video, or media content of solely one type. In the case of video, a representative still image is typically depicted in the filmstrip 306.

In some implementations, the GUI 302 is arranged so that when a user selects, or moves the cursor over, an image in the filmstrip 306, an enlarged view of the image is shown, as indicated by reference numeral 311. Additional details associated with the photograph or video are displayed such as title, author, date etc. Various input screens, menus, and dialog boxes may also be provided to enable users to provide comments and annotations to the media content. GUI 302 is also typically arranged to enable a user to perform any of a variety of activities and tasks with the pooled media content that is displayed as images in the filmstrip 306. For example, a user may select a piece of media content shown on the filmstrip 306 for printing, or multiple pieces may be arranged in a slideshow.

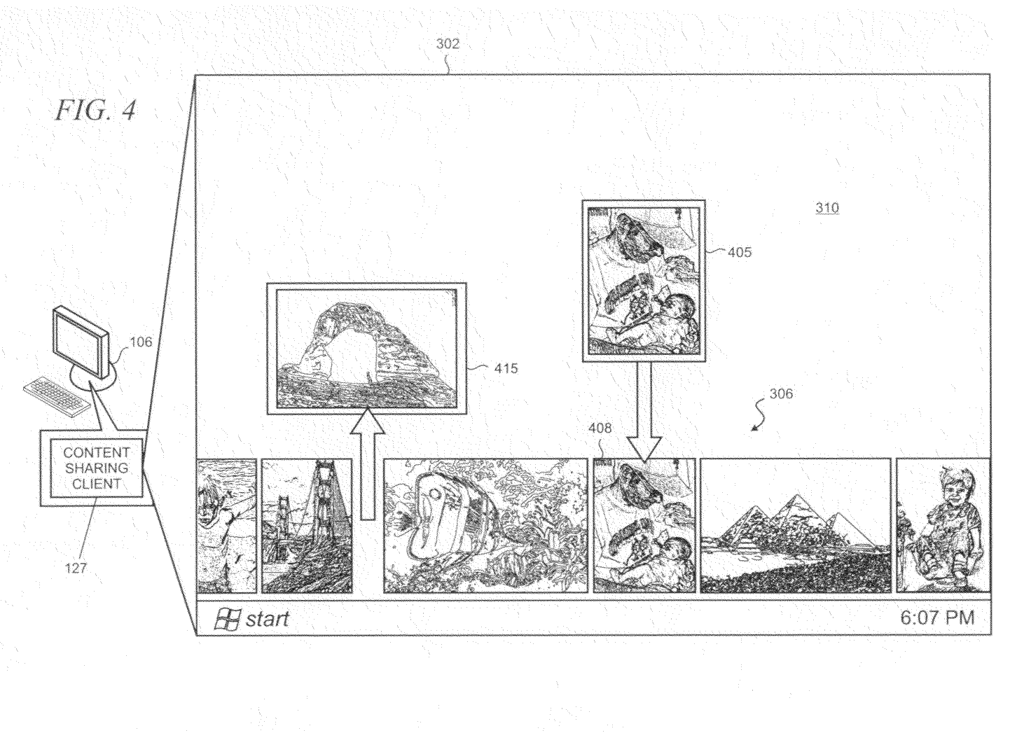

FIG. 4 shows a feature enabled by GUI 302 that is provided by the content sharing client 127. A user may add a piece of media content to the shared pool 110 (FIG. 1) by dragging its associated image 405 (i.e., an icon or thumbnail, etc.) from a folder (not shown) or the desktop 310 to the filmstrip 306, as indicated by reference numeral 408. Once placed into the filmstrip 306, the media content is transferred to the 110 by the content sharing service 127 (FIG. 1) so that it will become part of the shared media content on the filmstrip 306 that is viewable by all members of the group. In some implementations of the present arrangement, all users in the group may add new pieces of media content to the shared pool. In other implementations, a user privileges scheme is utilized so that only certain users may make additions to the media content pool.

GUI 302 also enables a user to manually delete a piece of media content from the shared pool 110, for example, by dragging its associated image from the filmstrip 306 to the desktop 310, a folder or to the recycle bin or trash (not shown). As depicted in FIG. 4, image 415 which was previously in the filmstrip 306 is moved to the desktop 310. In response to the user's interaction with GUI 302 by dragging the image 415 from the filmstrip 306, the content sharing service 127 deletes the associated media content from the media content pool 110 so that it is no longer viewable on the filmstrip 306 by any group members. Optionally, GUI 302 may be configured to allow only the owner of media content (i.e., the user who originally uploaded the media content to the pool 110) to manually delete media content from the pool 110.

As a result of its continuous display, filmstrip 306 does not provide a particular order to the media content. Thus, the concepts of “first” and “last” tend to lose their distinction in such a continuous display. However, it is still desirable to keep the filmstrip 306 fresh whereby new media content is not diluted by older content, particularly as the size of the filmstrip 306 grows in size over time. An aging model is therefore applied to media content in the pool 110 in which the interval of time that each piece of media content remains in the pool is tracked.

This time interval, or “virtual age,” of the media content is depicted on the filmstrip 306 through the use of visual metaphors. In literature, a metaphor is commonly defined as a figure of speech in which an expression is used to refer to something that it does not literally denote in order to suggest a similarity. The metaphors used here are visual and represent physical aging of an actual object such as a photograph that is imaged (e.g., printed) on photographic paper or stock. Hence, the suggestion put forth by the visual metaphor is aging of the media content as if it were a physical object in the real world.

As the virtual age of the media content in the pool 110 increases, visual metaphors—including optical deterioration such as fading, bleaching, desaturating, or yellowing, and physical deterioration such as tattering, tearing, fraying, dog-earring, creasing, cracking, and ripping—are overlaid as effects onto the content's representative image in the filmstrip 306. Older media content appears in the filmstrip 306 with increased fading, bleaching, or yellowing and with greater amounts of physical deterioration until, in some implementations of the present arrangement, the oldest images in the filmstrip 306 appear to crumble to dust, at which point the associated media content is deleted from the pool 110 by the content sharing service 127. This deletion is generally performed in an automated manner without user intervention so that maintenance of the media content pool can be accomplished with a minimal amount of effort. It is noted that the particular choice of visual metaphors used to represent a particular virtual age for media content can vary according to the needs of a specific implementation.

Another visual effect that may be usable in some implementations of the present arrangement is for an image in the filmstrip 306 to diminish in size as the virtual age of its associated media content in the media pool increases. Such diminution continues over time until the image recedes completely from view at which point the associated media content is deleted from the pool 110 by the content sharing service 127.

In most typical applications, the visual metaphors and effects are applied to the images in the filmstrip 306 to reflect virtual aging of the underlying media content in pool 110 as time progresses (i.e., virtual time and real time are synchronous). However, in an optional arrangement, virtual aging is counted asynchronously from real time. For example, media content in the pool 110 will not virtually age unless the media sharing client 127 is running. So if a user is away from the computer for a period of time, no virtual aging occurs and the visual metaphors and effects applied to the images in the filmstrip 306 will remain unchanged. When the user logs back on to the computer and launches client 127, then virtual aging restarts and the filmstrip images show increased simulated aging as time progresses.

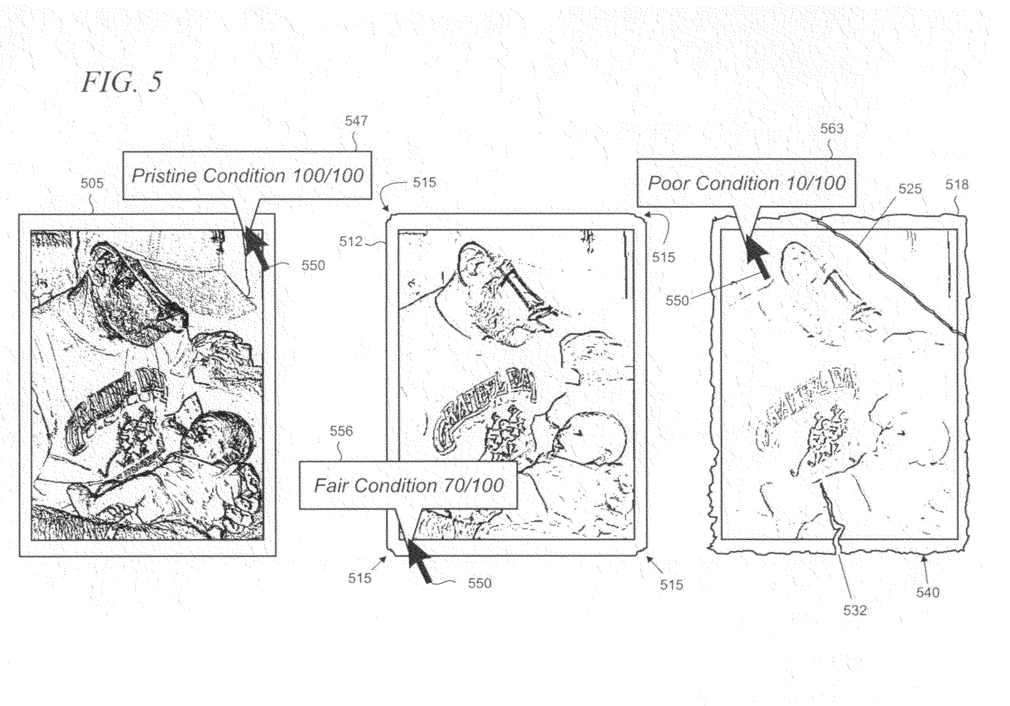

FIG. 5 shows a series of illustrative images in which different visual metaphors are used for different virtual ages of media content in the media pool 110 (FIG. 1). Image 505 shows an original image as displayed in filmstrip 306 (FIG. 3) that is associated with a piece of media content which, in this illustrative example, is a digital photograph of a man holding an infant. Image 505 is original and unaltered with no overlay of visual effects to indicate virtual age. Image 505 is thus considered “pristine” which is the condition for all new media content that is added to the media pool 110 in most typical implementations.

Image 512 shows the application of several illustrative visual metaphors to indicate an intermediate amount of virtual age of the content in the media pool 110. These visual metaphors are overlaid onto the image in the filmstrip 306, and are typically stored in a separate data structure or file so as not to perform any modifications to the underlying media content (i.e., the digital photograph of the man and the infant) itself. As shown, the image is faded so that detail is lost. In addition, the corners of the image are depicted as being worn (e.g., tattered and/or dog-eared), as indicated by reference numeral 515, as if the real physical printed photograph has been handled and exposed to sunlight over time. In addition to the loss of detail as shown in image 512, color effects may be utilized (although not shown in FIG. 5) such as yellowing, bleaching, or color desaturation of the image to visually simulate age.

Image 518 shows the application of several more illustrative visual metaphors to indicate a more advanced amount of virtual age of the media content in the pool 110. These visual metaphors include creasing 525, cracking 532, and ragged and torn edges 540 around the border of the image 518. In addition, image 518 includes a higher degree of fading than is evident with image 512. As before, all of the visual metaphors are overlaid onto the image as effects and do not represent modifications to the actual underlying digital photograph. Color effects may also be utilized. Here, the amount of color desaturation or yellowing would be greater than for an image with an intermediate amount of virtual aging.

While image 512 and 518 show two examples of the application of various visual metaphors for physical aging of an actual object, it is emphasized that how virtual aging is displayed between the pristine condition and the condition of virtually aged to the point of automatic deletion may vary by implementation. For example, in some implementations, the virtual age of media content may be tracked in discrete steps where each step is decremented by a counter as the media content ages with time. Pristine condition can start at 100 and automatic deletion from the pool 110 occurs when the counter gets decremented to zero. Various amounts of fading, desaturation, and physical deterioration (e.g., creasing, cracking, tearing etc.) may be applied to simulate physical aging at each step or a group of steps. For example, there could be discrete stages of virtual life for content in the media pool 110 with each stage being represented by a specific combination of visual metaphors. Alternatively, the application of the visual metaphors can be performed to visually display virtual aging in a more continuous manner.

In addition to visual metaphors, a text label may be utilized to replace or supplement the visual simulation of aging for the images on the filmstrip 306. With the example given above using a 100 to zero scale, such labels could include “pristine” or “mint” for 100, “good” for 80-90 and so on until the image is on its “last legs” when the counter decrements to the 0-10 range. Such text labels may be helpful, for example, to help novice users in a group understand how the visual metaphors correspond to virtual age and the length of time a particular piece of media content is retained in the filmstrip 305 and the pool 110.

Text labels may also be helpful in adding a measure of objectivity to the virtual aging model, for example, in cases where the image or subject matter contained therein does not lend itself to showing age using visual metaphors. While physical deterioration using tattering and cracking etc., is generally applicable to all images on the filmstrip 306, the use of fading, yellowing, bleaching etc., may not always be evident in some images. For example, images that do not contain a lot of color when in their pristine state might not appear to all users as being significantly different after fading or yellowing effects are overlaid. Some users might also have difficulty perceiving an image's condition when there is a lack of context or familiarity with the subject matter of the image (i.e., the user is unable to tell how the subject matter is supposed to appear).

Text labels may be displayed in any of a variety of conventional ways. As shown in FIG. 5, an illustrative text label 547 is arranged to be displayed, for example as a pop up, when the cursor 550 is positioned over image 505. Label 547 indicates that image 505 and its associated content in media pool 110 is in “pristine” or as-new condition with a numerical rating of 100 out of a possible 100. Illustrative text label 556 pops up when the cursor 550 is positioned over image 512. Label 556 shows a user that the media content has aged to the point where it is in “fair” condition with a numerical rating of 70 out of 100. Likewise, illustrative label 563 indicates that the media content is in poor condition with a numerical rating of just 10 out of 100.

In addition to displaying virtual age of media content displayed as images in the filmstrip 306, the GUI 302 (FIG. 3) displayed by the content sharing client 127 (FIG. 1) is further arranged to enable users to interact with media content stored in the pool 110 and rejuvenate selected media content to thereby reduce its virtual age. This is accomplished through use of a physical “polishing” metaphor in which a user can designate an image in the filmstrip 306 for a virtual renewal treatment that removes virtual age like tarnish is polished off an aged piece of silver.

When a user selects a virtually aged image in the filmstrip for polishing, the virtual age counter of its associated media content may be incremented to thereby return it to a newer condition, or back to its as-new, pristine condition. For example, an image having a virtual age counter of 50 may be restored back to 100 when polished by a user, and is displayed in filmstrip 306 in its original, pristine condition. In one illustrative example, a single polishing session can restore an image to an as-new, pristine condition regardless of its virtual age before polishing. In another illustrative example, an instance of polishing might only restore some youth back to the media content such that multiple polishing steps would be required for older content to be restored to new. In a third illustrative example, each time a user clicks on the image while in polishing mode, the counter is incremented by one. This is consistent with the polishing metaphor where each click represents a wipe by the polishing cloth to make the image cleaner with each successive wipe.

Polishing may be implemented as a feature that is explicitly invoked by a user. In this case, a user selects an image and then typically clicks a polishing command from a menu or toolbar, etc. provided by GUI 302. Various polishing options may be provided, in some implementations, for the user to select an amount of polishing to apply, or to designate a particular piece of media content to remain youthful indefinitely and not age (until such designation for eternal youth is removed).

In this illustrative example, any and all members of a group may polish any image in filmstrip 306 as it accumulates virtual age over time. In various optional implementations, it may be desirable to restrict polishing in some ways, or to provide the feature subject to a user privileges model. For example, a user might be restricted to only polishing media content added by others to the pool 110 and displayed as an image in filmstrip 306, but not the user's own content in the pool. Conversely, it might be desirable to let users polish only their own media content in the pool 110, but not content contributed by others in the group.

The automatic deletion feature noted above—in which media content that has virtually aged beyond a predetermined limit are deleted from the media pool 110−may also be implemented using a variety of options. One illustrative option is to remove the aged-out image from the filmstrip 306, but keep the associated media content in the pool 110. Another option is for all deleted media content, both aged-out and manually deleted, to be stored as part of a discarded content group that is kept separate and apart from the filmstrip 306. Members of the discarded group may still be viewed, for example, by invoking commands provided through GUI 302. In some implementations, members of the discarded group can be periodically flushed from the media pool 110 altogether.

Polishing may also be implemented as a feature that is implicitly invoked by a user. Here, media content that accumulates virtual age over time is automatically polished when a user performs an activity with the content such as adding a comment to an image in the filmstrip 306, arranging images from filmstrip 306 to a slideshow, printing, and the like. Thus, in general, the more a piece of media content is subjected to some sort of activity, the more polishing it receives. The amount of automatic polishing utilized for any given activity may be varied depending on the requirements of a specific application of the present automated maintenance arrangement. For example, in some implementations whenever a piece of media content is added by a group member to a slideshow, it is renewed back to pristine condition irregardless of its virtual age. In other implementations, such slideshow usage might only add 20 points of youth back to the media content (i.e., if the media content is in fair condition with a numerical rating of 70, it will be restored to good at 90, but not back to pristine condition).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented graphical user interface that is arranged for performing a method comprising the steps of:
representing media content stored in a pool as an image that is displayed on a computer desktop;
selecting a visual effect for simulating physical aging of the image, the selecting being performed responsively the media content's age in the pool; and
overlaying the visual effect on the image to indicate, to a user of the graphical user interface, the age of the media content.

2. The computer-implemented graphical user interface of claim 1 in which the image is displayed among a plurality of images, each of the images in the plurality representing media content being stored in the pool.

3. The computer-implemented graphical user interface of claim 2 in which the plurality of images is arranged as one of i) a filmstrip that continuously streams along a portion of the computer desktop, ii) a collage of images, or iii) an array of images arranged at least partially in a geometric form.

4. The computer-implemented graphical user interface of claim 1 in which the image depicts a photograph or a still video frame.

5. The computer-implemented graphical user interface of claim 1 in which the visual effect is one of a plurality of visual effects including at least one of fading, yellowing, bleaching, desaturating, tattering, creasing, fraying, cracking, tearing, dog-earring, ripping, diminution, or crumbling.

6. The computer-implemented graphical user interface of claim 5 in which additional ones of the plurality of visual effects are applied to the image as the age of the media content increases so that older media content in the pool is represented by an image showing greater simulated age.

7. The computer-implemented graphical user interface of claim 1 in which the media content is selected from one of digital photograph or digital video file.

8. The computer-implemented graphical user interface of claim 3 in which the method includes a further step of providing an interface by which a user adds new media content to the pool by dragging an image associated with the new media content into the filmstrip.

9. The computer-implemented graphical user interface of claim 3 in which the method includes a further step of providing an interface by which a user deletes a piece of media content from the pool by dragging an image associated with the piece of media content off the filmstrip.

10. The computer-implemented graphical user interface of claim 1 in which the method includes a further step of providing an interface to a user for selecting a piece of media content in the pool for which visual effects for simulating physical aging are removed from the selected piece of media content's representative image.

11. The computer-implemented graphical user interface of claim 10 in which the age of the selected piece of media content is tracked using a counter and the method includes a further step of invoking a process for changing the counter responsively to the selecting.

12. A shared media content service arranged as a software module, operable on a host, and arranged for performing a method comprising the steps of:
tracking age of media content held in a shared pool, the shared pool being accessible by one or more media content sharing clients;
sending the age to the one or more media content sharing clients to enable application, by a graphical user interface provided by the one or more media content sharing clients, of a simulated aging effect to an image representing the media content; and
deleting media content from the shared pool when the age reaches a threshold.

13. The shared media content service of claim 12 in which the shared media content service communicates with the one or more media content sharing clients over one of a network or IPC process.

14. The shared media content service of claim 12 in which the host is a central server.

15. The shared media content service of claim 12 in which the simulated aging effect is one of fading, yellowing, bleaching, desaturating, tattering, creasing, fraying, cracking, tearing, dog-earring, ripping, diminution, or crumbling.

16. A method for displaying age of media content in a pool, the method comprising the steps of:
representing the pool as a group of images in a shared space that is accessible by a group of users; and
applying a visual metaphor to a selected image in the shared space to simulate physical characteristics of a photograph imaged on photographic stock as the photograph ages over time, the image being selected based on a virtual age of the media content in the pool.

17. The method of claim 16 including a further step of deleting an image from the shared space as the virtual age of media content exceeds a set limit.

18. The method of claim 16 in which the shared space is displayed by each of a plurality of clients associated with the group of users.

19. The method of claim 18 including a further step of receiving input from a user in the group to reduce the virtual age of the media content, the input being implemented through use of a polishing feature by which the user removes simulated physical characteristics of aging from the selected images.

20. The method of claim 16 in which the visual metaphor represents one of optical deterioration or physical deterioration.
